(19) United States
(12) Patent Application Publication
(10) Pub. No.: US 2018/0089282 A1
(43) Pub. Date: Mar. 29, 2018

(54) USER-DRIVEN PAGING

(71) Applicant: Microsoft Technology Licensing, LLC., Redmond, WA (US)

(72) Inventors: Somanath Krishnaswamy, Redmond, WA (US); Jeffrey James Wall, Sammamish, WA (US); Ilya David Gorelik, Seattle, WA (US); Kent Mai, Issaquah, WA (US)

(73) Assignee: Microsoft Technology Licensing, LLC., Redmond, WA (US)

(21) Appl. No.: 15/274,133

(22) Filed: Sep. 23, 2016

(51) Int. Cl. G06F 17/30

(52) U.S. Cl. CPC G06F 17/30554; G06F 17/30551; G06F 17/30477

(57) ABSTRACT

Systems, methods and computer-readable media for providing user-driven paging are disclosed. When a user inputs a search query within a productivity application that is configured to support user-driven paging, the system retrieves a portion of the items responsive to the search query and displays the items in the search results. In response to user interactions with the search results, the system retrieves another portion of the items responsive to the search query in anticipation of additional user interactions, thereby providing a seamless presentation of search results, reducing network traffic, and improving network efficiency/performance.

### BACKGROUND

Computer users frequently utilize one or more productivity applications, including messaging applications, in their daily activities. Using these productivity applications, a computer user will generate and/or receive a voluminous amount of content items. In order to locate a specific content item within the content items, a computer user will typically perform a search query using one or more keywords.

In response to receiving the search query, the computer performs a search using the one or more keywords and displays the search results in the productivity application. However, most productivity applications retrieve and display all of the search results at the same time. Alternatively, the productivity applications retrieve all of the search results, but display the search results on multiple pages. Accordingly, the productivity applications also display one or more buttons or links, such as page 1, 2, 3 . . . N, which when selected cause the productivity application to navigate to a page associated with different portions of the search results.

### SUMMARY

This summary is provided to introduce a selection of concepts in a simplified form that are further described below in the Detailed Description section. This summary is not intended to identify all key or essential features of the claimed subject matter, nor is it intended as an aid in determining the scope of the claimed subject matter.

Systems, methods and computer-readable media for providing user-driven paging are disclosed. According to aspects, when a user inputs a search query within a productivity application that is configured to support user-driven paging, the system retrieves items responsive to the search query and displays the items in the search results. More particularly, the system retrieves a portion of the items sufficient to enable user-driven paging while providing the appearance that all of the search results are available. Further, in response to user interactions with the search results, the system retrieves another portion of items responsive to the search query in anticipation of additional user interactions, which provides a seamless user experience when interacting with the search results. Aspects of user-driven paging provide numerous advantages in the presentation of voluminous amounts of search results, including improvements to the presentation of a seamless user experience, reduced network traffic, and network efficiency/performance. Therefore, a computer using user-driven paging improves the functioning of the computer itself or effects an improvement in a network or another computer.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram of a representation of an example operating environment including the system for user-driven paging;

FIG. 2 is an illustration of an example graphical user interface displaying a productivity application providing user-driven paging;

FIG. 3 is a flow chart showing general stages involved in an example method for providing user-driven paging;

FIG. 4 is a block diagram illustrating example physical components of a computing device;

FIGS. 5A and 5B are block diagrams of a mobile computing device; and

FIG. 6 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Systems, methods and computer-readable medium for providing user-driven paging are disclosed. According to aspects, when a user inputs a search query within a productivity application that is configured to support user-driven paging, the system retrieves items responsive to the search query and displays the items in the search results. More particularly, the system retrieves a portion of the items sufficient to enable user-driven paging while providing the appearance that all of the search results are available. Further, in response to user interactions with the search results, the system retrieves another portion of items responsive to the search query in anticipation of additional user interactions, which provides a seamless user experience when interacting with the search results. Aspects of user-driven paging provide numerous advantages in the presentation of voluminous amounts of search results, including improvements to the presentation of a seamless user experience, reductions in network traffic, and improvements to network efficiency/performance. Therefore, a computer using user-driven paging improves the functioning of the computer itself or effects an improvement in a network or another computer.

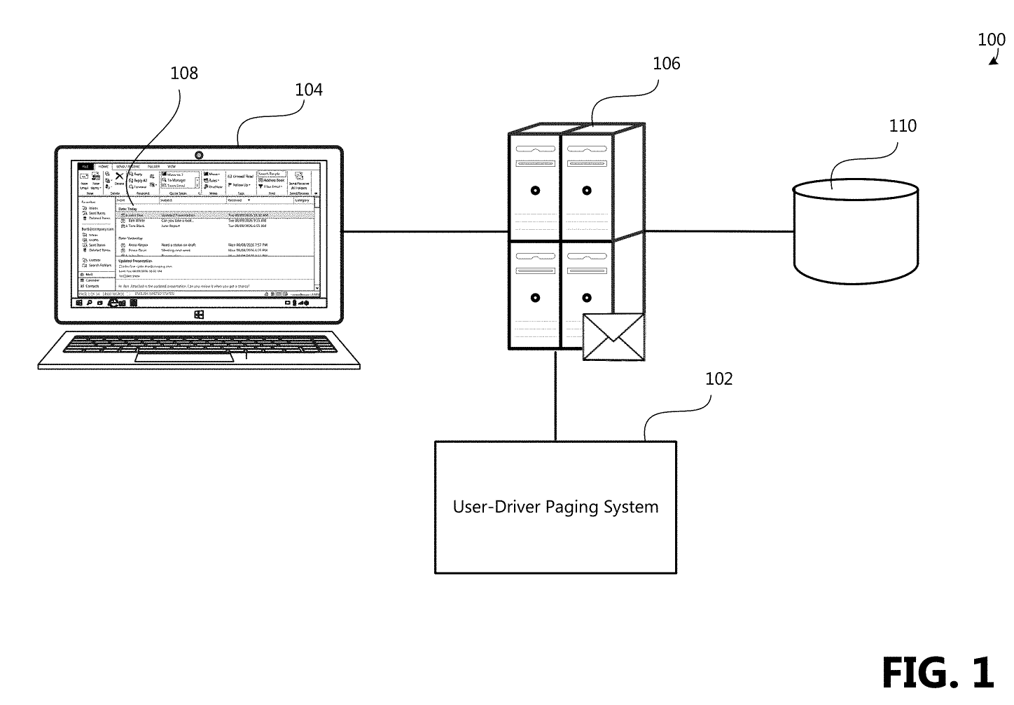

With reference now to FIG. 1, a block diagram of one example environment 100 in communication with a user-driven paging system 102 is shown. As illustrated, the example environment 100 includes a first computing device 104, utilized by a user, which is in communication with a second computing device 106. The second computing device 106 is in communication a content item repository 110 to provide the first computing device 104 with content items from the content item repository 110 that satisfy search queries submitted from the first computing device 104. The user-driven paging system 102 governs the amount of results that the second computing device 106 retrieves from the content item repository 110 based on the display area and user interactions from the first computing device 104 to provide user-driven paging, when appropriate.

It should be recognized that the first computing device 104 may include a desktop computer, a laptop computer, a tablet computer, a messaging server, a handheld computing device, a mobile communication device, a wearable device, a gaming device, and the like. The second computing device 106 may be in the form of a cloud-based service provided by a server, a network server, an enterprise system, a desktop computer, a laptop computer, a tablet computer, a handheld computing device, a mobile communication device, and the like. The content item repository 110 may be in the form of a computer device or computer readable storage medium that maintains content items that a user may search for, such as, for example, an email archive, storing content items of email messages, a document management server, storing productivity application documents for an enterprise, a hard drive, storing the files accessible by a computing device, etc. In various aspects, the first computing device 104, the second computing device 106, and the content item repository may be implemented in one device or implemented separate devices in communication with one another.

Further, the first computing device 104 in the example environment 100 utilizes a client or productivity application 108 executing on the first computing device 104. The productivity application 108 includes applications used for authoring documents locally on a user machine, collaboratively across multiple user machines, or online via a server as a remote application. Examples of productivity applications that may be used locally or collaboratively include, but are not limited to: the Office suite of productivity tools (available from Microsoft, Corp. of Redmond, Wash.), the Outlook® messaging application, the Gmail™ messaging application (available from Alphabet, Inc. of Mountain View, Calif.), the Mail messaging application (available from Apple, Inc. of Cupertino, Calif.). Such productivity applications may store content items locally or in the cloud via cloud storage solutions, such as, for example, Google Drive™ or OneDrive® (available from Alphabet, Inc. and Microsoft, Corp., respectively).

Further, the productivity application 108 is operable to receive input data including content items from the content item repository 110. Specifically, the productivity application 108 on the first computing device 104 is configured to communicate with the second computing device 106 to locate and facilitate in the identification, retrieval and/or storage of the content items from the content item repository 110. The user-driven paging system 102 governs the amount of content items that may be searched for and responsive content items that may be returned at one time based on the display properties for search results and user actions within the productivity application. By governing the search process, the user-driven paging system 102 provides an initial sub-set of the possible search results based on the display area available in the productivity application, and subsequently provides additional sub-sets of the search results to augment the initial (and prior-provided) search results as the user browses the provided results on the search page that displayed the initial sub-set of search results (i.e., without having to break the search results into separately requested pages of results).

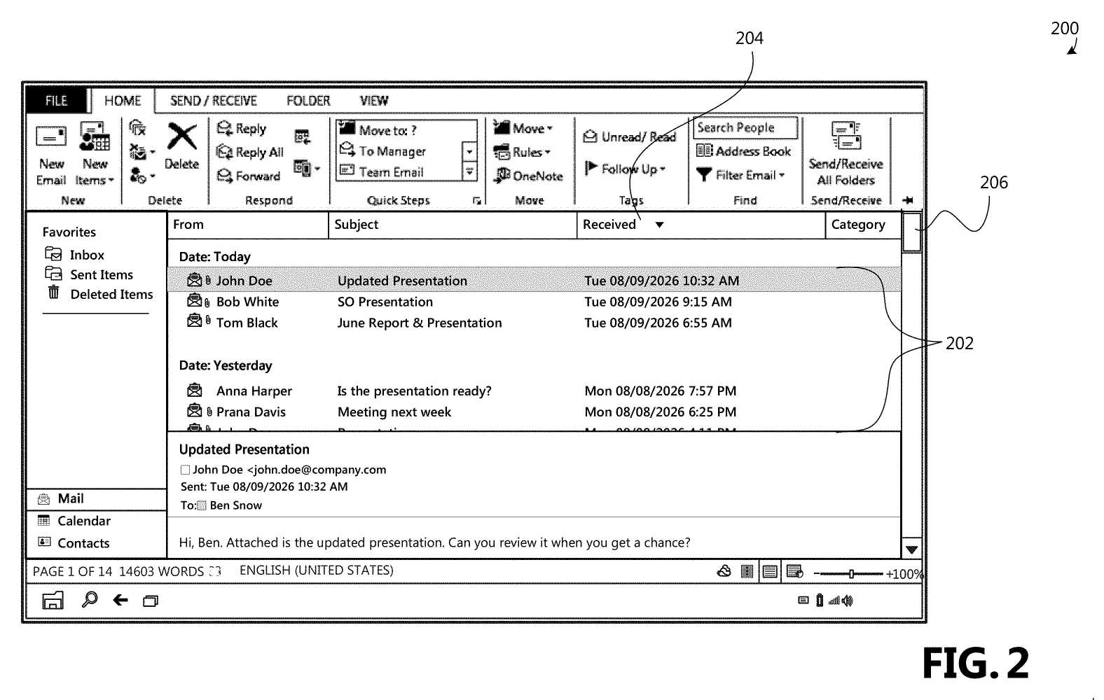

FIG. 2 is an illustration showing an application user interface 200 for displaying content items in a productivity application 108 utilizing the user-driven paging system 102 on a computing device. In the illustrated example, the application user interface 200 is displaying an example search results 202 comprising content items responsive to a search query for “presentation.”

According to aspects of the user-driven paging system 102, the settings of the productivity application 108 are configured to support user-driven paging. In the illustrated example, the search results are being displayed chronologically based on the date received 204. Further, it should be noted that the productivity application 108 retrieves and displays a sufficient portion of content items for enabling the user to scroll through the search results via a scroll control 206. In situations when the user only views the first page of search results, the user-driven paging system 102 reduces network traffic and improves network efficiency/performance as a result of only retrieving a portion of the content items.

In the event that the user scrolls though the search results, the system detects the presentation of the search results requires additional content items to provide a seamless user experience. Accordingly, the system retrieves another portion of content items to incorporate into the presentation of the search results. However, it should be recognized that the user-driven paging system 102 continues to reduce network traffic and improve network efficiency/performance by only retrieving another portion of the content items. As a result, the user-driven paging system 102 provides the user with a seamless user experience of browsing through as many search results as the user desires.

Additionally, if the user decides to change the settings of the productivity application 108 to no longer support user-driven paging, the productivity application 108 displays the search results in a traditional environment.

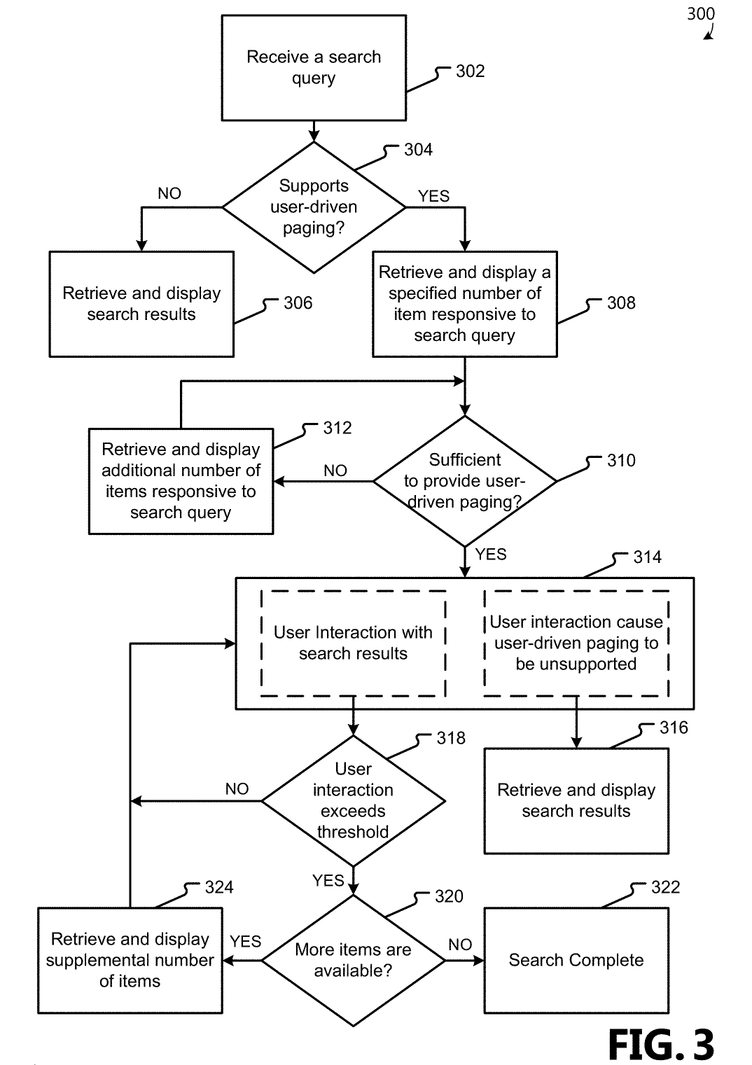

FIG. 3 is a flow chart showing general stages involved in an example method 300 for improving accuracy and computer efficiency in providing seamless user-driven paging. The method 300 begins at OPERATION 302, where the computing system receives a search query. According to one aspect, a user inputs the search query within a productivity application 108 in a desktop environment. According to other aspects, the user inputs the search query within an online productivity application 108.

The method 300 proceeds to OPERATION 304, where the computing system determines whether the functionality of the productivity application 108 supports user-driven paging. According to one aspect, the computing system analyzes the current settings associated with the display of content items within the productivity application 108. For example, the computing system determines whether the current sorting settings of the content items within the productivity application 108 support user-driven paging. According to one example, the computing device determines that the productivity application 108 supports user-driven paging when sorting settings indicate a chronological or reverse chronological order of display for the search results 202 within the productivity application 108. In another example, the computing device determines that the productivity application 108 does not support user-driven paging when sorting settings alphabetically organize the content items within the productivity application 108. In other examples, the computing device determines that the productivity application 108 supports user-driven paging based on other sort settings.

When the computing device determines that the functionality of the productivity application 108 does not support user-driven paging, the method 300 proceeds to OPERATION 306, where the computing system retrieves and displays search results responsive to the search query. According to one aspect, the computing system retrieves and displays all of the items responsive to the search query. According to another aspect, the computing system specifies a number of items to retrieve and display in the results for the search results. For example, the computing system retrieves and displays two hundred and fifty (250) items in the results for the search results 202. It should be recognized that in other aspects the computing system may specify another number of items to retrieve and display in the results for the search results.

When the computing device determines that the functionality of the productivity application 108 supports user-driven paging, the method 300 proceeds to OPERATION 308, where the computing system retrieves a specified number of items responsive to the search query for display in the search results. For example, according to one aspect, the computing system retrieves seventy-five (75) items responsive to the search query for display in the search results. In another example, the computing system retrieves twenty-five (25) items responsive to the search query. In other examples, the computing system retrieves a percentage of the items responsive to the search query. According to one aspect, the computing system also determines whether additional items responsive to the search query are available.

The method 300 proceeds to OPERATION 310, where the computing system determines whether the display of the search results is sufficient to provide user-driven paging in the productivity application 108. According to one aspect, the computing system determines whether the productivity application 108 has unused screen space when the specified number of items is displayed in the search results. For example, the computing system determines whether the productivity application 108 displays whitespace below the specified number of items in the search results. According to another aspect, the computing system determines whether the productivity application 108 provides functionality associated with the search results. For example, the computing system determines whether the specified number of items in the search results extends beyond the viewable space causing the productivity application 108 to display scrolling functionality. According to yet another aspect, the computing system determines whether the specified number of items are displayed in multiple pages of the productivity application 108.

When the specified number of items is insufficient to provide user-driven paging when the search results are displayed in the productivity application 108, the method 300 proceeds to OPERATION 312, where the computing system retrieves an additional number of items responsive to the search query and displays the search results, including the specified number of items and the additional number of items. In one example, the computing system retrieves the same number of additional number of items as the specified number of items. In another example, the additional number of items is less than the specified number of items that was previously retrieved. In yet another example, the additional number of items is more than the specified number of items that was previously retrieved. Further, in accordance with one aspect, the computing system returns to OPERATION 310 and OPERATION 312 until the display of the search results is sufficient to provide user-driven paging in the productivity application 108.

The method 300 proceeds to OPERATION 314, where the computing system receives a user input. According to one aspect, user input is an interaction with the search results. For example, the user input includes an interaction of scrolling within the search results. In another example, the user input includes a hardware-based interaction. In yet another example, the user input includes a gesture interaction to move within the search results. According to another aspect, the computing system receives a user input that changes the functionality of the productivity application 108 to not support user-driven paging.

When the computing system receives a user input that changes the functionality of the productivity application 108 to not support user-driven paging, the method 300 proceeds to OPERATION 316, where the computing system retrieves and displays search results responsive to the search query. Like in OPERATION 306, the computing system may retrieve all of the items or a specified number of items responsive to the search query and displays the search results.

When the user input is an interaction with the search results, the method 300 proceeds to OPERATION 318, where the computing system determines whether the interaction with the search results exceeds a threshold. According to one aspect, the computing system determines whether the user has scrolled a threshold number of items within the search results. For example, the computing system may determine whether the user has scrolled down approximately fifty items within the search results. According to another aspect, the computing system determines whether the user has scrolled through a threshold percentage of the search results. In one example, the threshold percentage is approximately two-thirds of the search results, or another intermediary location, i.e., not at the end of the search results being displayed. According to yet another aspect, the computing system determines whether the user has started to scroll through the search results. Further, it should be recognized that the computing system may otherwise establish a threshold for the interaction to determine when the user is nearing the end of the search results.

When the interaction has not exceeded a threshold, the computing system continues to display the current search results according to the user interaction. When the interaction with the search results exceeds a threshold, the method 300 proceeds to OPERATION 320, where the computing system determines whether more items responsive to the search query are available.

When the computing system determines that more items responsive to the search query are unavailable, the method 300 proceeds to OPERATION 322, where the computing system determines that the search is completed.

When the computing system determines that more items responsive to the search query are available, the method 300 proceeds to OPERATION 324, where the computing system retrieves a supplemental number of items responsive to the search query for inclusion within the search results. According to one aspect, the computing system retrieves the same number of supplemental items as the specified number of items. In another example, the supplemental number of items is more or less than the specified number of items that was previously retrieved. According to one aspect, the supplemental number of items incrementally increases upon a subsequent retrieval of items responsive to the search query. For example, the computing device retrieves seventy-five (75) items during a first retrieval and retrieves one hundred (100) items during a second retrieval, etc. The method 300 thereafter returns to OPERATION 314.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

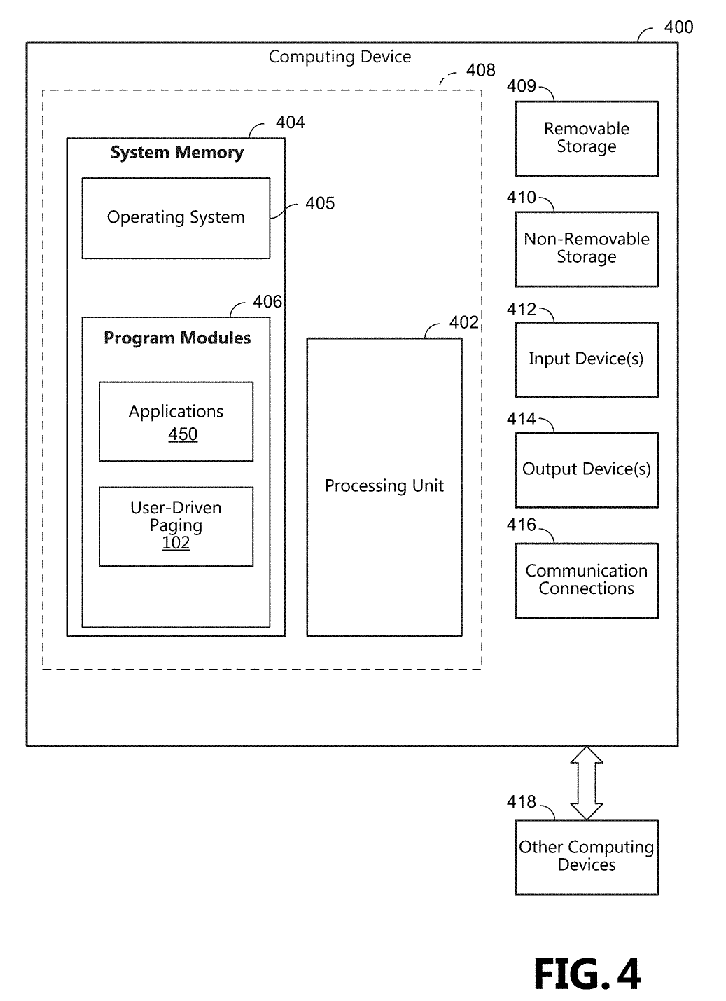

FIGS. 4-6 and the associated descriptions provide a discussion of a variety of operating environments in which examples are practiced. However, the devices and systems illustrated and discussed with respect to FIGS. 4-6 are for purposes of example and illustration and are not limiting of a vast number of computing device configurations that are utilized for practicing aspects, described herein.

FIG. 4 is a block diagram illustrating physical components (i.e., hardware) of a computing device 400 with which examples of the present disclosure may be practiced. In a basic configuration, the computing device 400 includes at least one processing unit 402 and a system memory 404. According to an aspect, depending on the configuration and type of computing device, the system memory 404 comprises, but is not limited to, volatile storage (e.g., random access memory), non-volatile storage (e.g., read-only memory), flash memory, or any combination of such memories. According to an aspect, the system memory 404 includes an operating system 405 and one or more program modules 406 suitable for running software applications 450. According to an aspect, the system memory 404 includes user-driven paging system 102. The operating system 405, for example, is suitable for controlling the operation of the computing device 400. Furthermore, aspects are practiced in conjunction with a graphics library, other operating systems, or any other application program, and are not limited to any particular application or system. This basic configuration is illustrated in FIG. 4 by those components within a dashed line 408. According to an aspect, the computing device 400 has additional features or functionality. For example, according to an aspect, the computing device 400 includes additional data storage devices (removable and/or non-removable) such as, for example, magnetic disks, optical disks, or tape. Such additional storage is illustrated in FIG. 4 by a removable storage device 409 and a non-removable storage device 410.

As stated above, according to an aspect, a number of program modules and data files are stored in the system memory 404. While executing on the processing unit 402, the program modules 406 (e.g., user-driven paging system 102) perform processes including, but not limited to, one or more of the stages of the method 300 illustrated in FIG. 3. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, the computing device 400 has one or more input device(s) 412 such as a keyboard, a mouse, a pen, a sound input device, a touch input device, etc. The output device(s) 414 such as a display, speakers, a printer, etc. are also included according to an aspect. The aforementioned devices are examples and others may be used. According to an aspect, the computing device 400 includes one or more communication connections 416 allowing communications with other computing devices 418. Examples of suitable communication connections 416 include, but are not limited to, radio frequency (RF) transmitter, receiver, and/or transceiver circuitry; universal serial bus (USB), parallel, and/or serial ports.

The term computer readable media, as used herein, includes computer storage media. Computer storage media include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. According to an aspect, any such computer storage media is part of the computing device 400. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

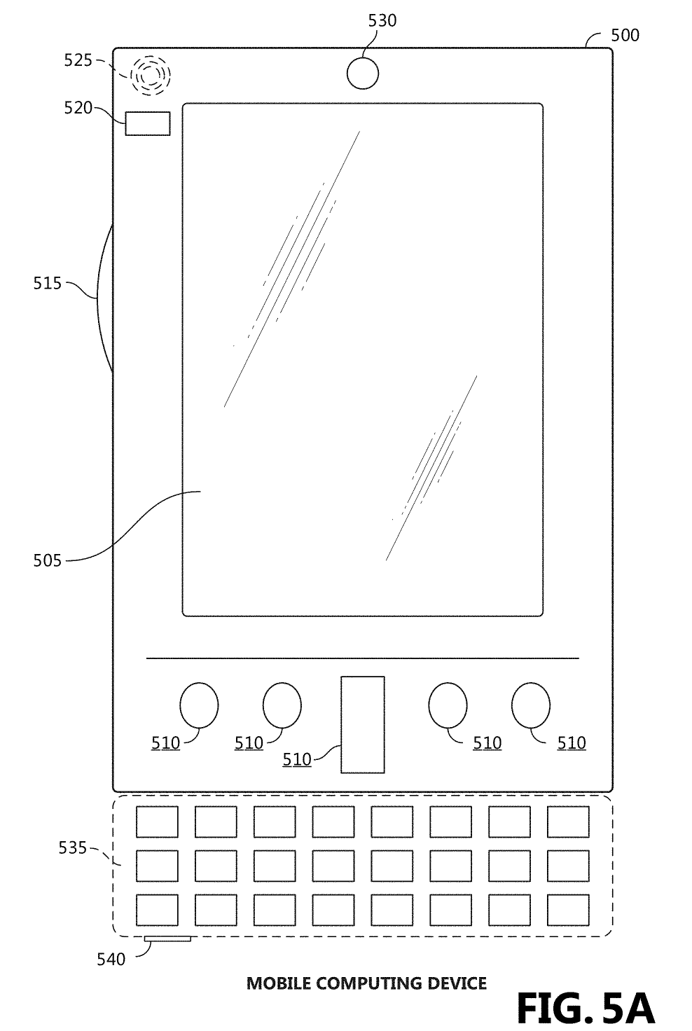

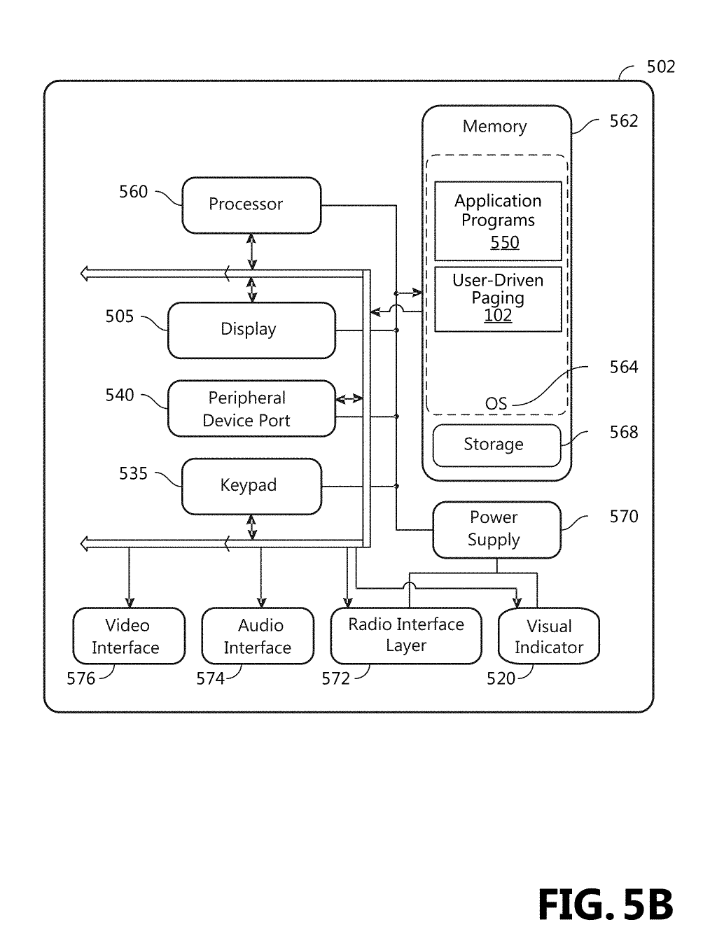

FIGS. 5A and 5B illustrate a mobile computing device 500, for example, a mobile telephone, a smart phone, a tablet personal computer, a laptop computer, and the like, with which aspects may be practiced. With reference to FIG. 5A, an example of a mobile computing device 500 for implementing the aspects is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. According to an aspect, the display 505 of the mobile computing device 500 functions as an input device (e.g., a touch screen display). If included, an optional side input element 515 allows further user input. According to an aspect, the side input element 515 is a rotary switch, a button, or any other type of manual input element. In alternative examples, mobile computing device 500 incorporates more or fewer input elements. For example, the display 505 may not be a touch screen in some examples. In alternative examples, the mobile computing device 500 is a portable phone system, such as a cellular phone. According to an aspect, the mobile computing device 500 includes an optional keypad 535. According to an aspect, the optional keypad 535 is a physical keypad. According to another aspect, the optional keypad 535 is a “soft” keypad generated on the touch screen display. In various aspects, the output elements include the display 505 for showing a graphical user interface (GUI), a visual indicator 520 (e.g., a light emitting diode), and/or an audio transducer 525 (e.g., a speaker). In some examples, the mobile computing device 500 incorporates a vibration transducer for providing the user with tactile feedback. In yet another example, the mobile computing device 500 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 500 incorporates peripheral device port 540, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one example of a mobile computing device. That is, the mobile computing device 500 incorporates a system (i.e., an architecture) 502 to implement some examples. In one example, the system 502 is implemented as a “smart phone” capable of running one or more applications (e.g., browser, e-mail, calendaring, contact managers, messaging clients, games, and media clients/players). In some examples, the system 502 is integrated as a computing device, such as an integrated personal digital assistant (PDA) and wireless phone.

According to an aspect, one or more application programs 550 are loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. According to an aspect, user-driven paging system 102 is loaded into memory 562. The system 502 also includes a non-volatile storage area 568 within the memory 562. The non-volatile storage area 568 is used to store persistent information that should not be lost if the system 502 is powered down. The application programs 550 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500.

According to an aspect, the system 502 has a power supply 570, which is implemented as one or more batteries. According to an aspect, the power supply 570 further includes an external power source, such as an AC adapter or a powered docking cradle that supplements or recharges the batteries.

According to an aspect, the system 502 includes a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of the operating system 564. In other words, communications received by the radio 572 may be disseminated to the application programs 550 via the operating system 564, and vice versa.

According to an aspect, the visual indicator 520 is used to provide visual notifications and/or an audio interface 574 is used for producing audible notifications via the audio transducer 525. In the illustrated example, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. According to an aspect, the system 502 further includes a video interface 576 that enables an operation of an on-board camera 530 to record still images, video stream, and the like.

According to an aspect, a mobile computing device 500 implementing the system 502 has additional features or functionality. For example, the mobile computing device 500 includes additional data storage devices (removable and/or non-removable) such as, magnetic disks, optical disks, or tape. Such additional storage is illustrated in FIG. 5B by the non-volatile storage area 568.

According to an aspect, data/information generated or captured by the mobile computing device 500 and stored via the system 502 are stored locally on the mobile computing device 500, as described above. According to another aspect, the data are stored on any number of storage media that are accessible by the device via the radio 572 or via a wired connection between the mobile computing device 500 and a separate computing device associated with the mobile computing device 500, for example, a server computer in a distributed computing network, such as the Internet. As should be appreciated such data/information are accessible via the mobile computing device 500 via the radio 572 or via a distributed computing network. Similarly, according to an aspect, such data/information are readily transferred between computing devices for storage and use according to well-known data/information transfer and storage means, including electronic mail and collaborative data/information sharing systems.

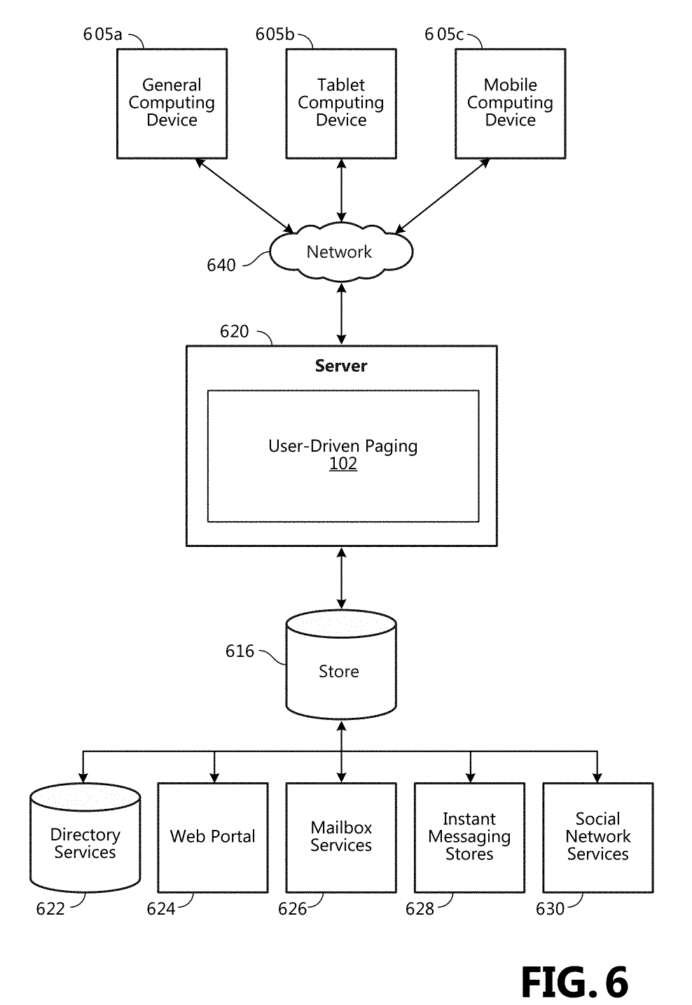

FIG. 6 illustrates one example of the architecture of a system for user-driven paging system as described above. Content developed, interacted with, or edited in association with the user-driven paging system 102 is enabled to be stored in different communication channels or other storage types. For example, various documents may be stored using a directory service 622, a web portal 624, a mailbox service 626, an instant messaging store 628, or a social networking site 630. The user-driven paging system 102 is operative to use any of these types of systems or the like for providing a seamless user experience, reduced network traffic, and improved network efficiency/performance as described herein. According to an aspect, a server 620 provides the user-driven paging system 102 to clients 605a,b,c. As one example, the server 620 is a web server providing the user-driven paging system 102 over the web. The server 620 provides the user-driven paging system 102 over the web to clients 605 through a network 640. By way of example, the client computing device is implemented and embodied in a personal computer 605a, a tablet computing device 605b or a mobile computing device 605c (e.g., a smart phone), or other computing device. Any of these examples of the client computing device are operable to obtain content from the store 616.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

1. A method for providing user-driven paging, comprising:
receiving a search query;
determining whether the functionality of a productivity application supports user-driven paging;
when the functionality of the productivity application supports user-driven paging, retrieving a specified number of items responsive to the search query and displaying the specified number of items as search results in a display area of the productivity application;
determining whether the search results are sufficient to enable user-driven paging in the productivity application;
when the search results are insufficient to enable user-driven paging in the productivity application, retrieving an additional number of items responsive to the search query and displaying the specified number of items and the additional number of items as the search results in the display area;
receiving a user input;
when the user input is an interaction with the search results, determining whether the interaction with the search results exceeds a threshold; and
retrieving a supplemental number of items responsive to the search query for inclusion within the search results.

2. The method of claim 1, further comprising when the computing device determines that the functionality of the productivity application does not support user-driven paging, retrieving and displaying all of the items responsive to the search query as the search results.

3. The method of claim 1, further comprising when the user input changes the functionality of the productivity application to not support user-driven paging, retrieving and displaying all of the items responsive to the search query as the search results.

4. The method of claim 1, further comprising determining whether more items responsive to the search query are available.

5. The method of claim 1, wherein the interaction with the search results exceeds a threshold when the user has scrolled a threshold number of items within the display area.

6. The method of claim 1, wherein the interaction with the search results exceeds a threshold when the user scrolled through a threshold percentage of the search results.

7. The method of claim 1, wherein the interaction with the search results exceeds a threshold when the user is nearing the end of the search results.

8. The method of claim 1, wherein requesting an additional number of items responsive to the search query for inclusion within the search results occurs in response to determining that more items responsive to the search query are available.

9. The method of claim 1, wherein determining whether the functionality of the productivity application supports user-driven paging further comprises determining whether the current sorting settings of the productivity application supports user-driven paging.

10. The method of claim 9, wherein the functionality of the productivity application supports user-driven paging when the productivity application sorts the items in chronological or reverse chronological order.

11. The method of claim 1, wherein determining whether the search results are sufficient to enable user-driven paging in the productivity application further comprises determining whether the productivity application has unused screen space in the display area when the specified number of items is displayed in the display area.

12. The method of claim 11, wherein determining whether the search results are sufficient to enable user-driven paging in the productivity application further comprises determining whether the productivity application displays whitespace in the display area.

13. A system for providing user-driven paging, comprising:
a processing unit; and
a memory including computer readable instructions, which when executed by the processing unit, causes the system to be operable to:
receive a search query;
retrieve a specified number of items responsive to the search query and display the specified number of items as search results in a display area of the productivity application;
determine whether the search results are sufficient to enable user-driven paging in the productivity application;
when the search results are insufficient to enable user-driven paging in the productivity application, retrieve an additional number of items responsive to the search query and display the specified number of items and the additional number of items as the search results;
receive a user input;
when the user input is an interaction with the search results, determine whether the interaction with the search results exceeds a threshold, wherein the threshold is an intermediary location in the search results;
in response determining the interaction with the search results exceeds a threshold, determine whether more items responsive to the search query are available; and
in response to determining more items are responsive to the search query are available, request the supplemental number of items responsive to the search query for inclusion within the search results.

14. The system of claim 13, wherein the interaction with the search results exceeds a threshold when the user has scrolled a threshold number of items within the search results.

15. The system of claim 13, wherein the interaction with the search results exceeds a threshold when the user scrolled through a threshold percentage of the search results.

16. (canceled)

16. (canceled)

17. The system of claim 13, wherein to request an additional number of items responsive to the search query for inclusion within the search results occurs in response to determining that more items responsive to the search query are available.

18. The system of claim 13, wherein determining whether the search results are sufficient to enable user-driven paging in the productivity application further comprises determining whether the productivity application has unused screen space in the display area when the specified number of items is displayed in the display area.

19. The system of claim 18, wherein determining whether the search results are sufficient to enable user-driven paging in the productivity application further comprises determining whether the productivity application displays whitespace in the display area.

20. A computer readable storage device including computer readable instructions, which when executed by a processing unit, performs steps for user-driven paging, comprising:
receiving a search query from a productivity application;
determining, by a computing device, whether the functionality of the productivity application supports user-driven paging;
when the computing device determines that the functionality of the productivity application does not support user-driven paging, retrieving and displaying all of the items responsive to the search query as search results in a display area of the productivity application;
when the computing device determines that the functionality of the productivity application supports user-driven paging, retrieving a specified number of items responsive to the search query and displaying the specified number of items as the search results in the display area of the productivity application;
determining whether the specified number of items is sufficient to provide user-driven paging in the productivity application, wherein the specified number of items is insufficient to provide user-driven paging when the display area displaying the search results in the productivity application includes whitespace and is sufficient to provide user-driven paging when the display area displaying the search results does not include whitespace;
in response to determining that the specified number of items is insufficient to provide user-driven paging, retrieving an additional number of items responsive to the search query and displaying the specified number of items and the additional number of items in the search results;
receiving a user input;
when the user input changes the functionality of the productivity application to not support user-driven paging, retrieving and displaying all of the items responsive to the search query as the search results;
when the user input is an interaction with the search results, determining whether the interaction with the search results exceeds a threshold;
when the interaction with the search results exceeds a threshold, determining whether more items responsive to the search query are available;
in response to determining that more items responsive to the search query are unavailable, completing the search; and
in response to determining that more items responsive to the search query are available, requesting a supplemental number of items responsive to the search query for inclusion within the search results.

21. The system of claim 13, wherein the interaction with the search results exceeds a threshold when the user is nearing the end of the search results.

22. The system of claim 13, further comprising determining whether more items responsive to the search query are available.
